(19) United States
(12) Patent Application Publication
(10) Pub. No.: US 2007/0140766 A1
(43) Pub. Date: Jun. 21, 2007

(54) Rotatable connection apparatus for fixing position of object to be rotated via friction adjustment

(76) Inventor: Kuo-Feng Huang, Nan-Tou Hsien (TW)

Correspondence Address: NORTH AMERICA INTELLECTUAL PROPERTY CORPORATION, P.O. BOX 506, MERRIFIELD, VA, 22116, US

(21) Appl. No.: 11/309,890

(22) Filed: Oct. 17, 2006

(30) Foreign Application Priority Data
Oct. 17, 2005 (TW) 094136147

(51) Int. Cl. G03G 15/00

(52) U.S. Cl. 399/380

(57) ABSTRACT

A rotatable connection apparatus is disclosed including: a roller coupled to an object to be rotated, wherein the roller rotates with the rotation of the object; a frictional component for contacting a surface of the roller to provide a friction for fixing the object in a first position when the object is rotated to the first position; and an elastic component having a terminal coupled to the frictional component and another terminal coupled to an fixed position, wherein the elastic component is deformed to adjust the friction between the roller and the frictional component when the object is rotated to the first position.

### BACKGROUND OF THE INVENTION

1. Field of the Invention

The present disclosure relates to a connection apparatus, and more particularly, to a rotatable connection apparatus that utilizes an elastic component to adjust the friction between a roller and a frictional component so as to fix an object to be rotated in a certain position.

2. Description of the Prior Art

In practical applications, many products (e.g., some cell phones, scanners, or copy machines) are provided with a cover or a similar part, so that the user can open the cover while uses the product and close the cover to protect important components of the product or against dust when the product is not in use. The cover is typically connected to the main body of the product through a connection apparatus. The connection apparatus must be a rotatable connection apparatus so that the user can freely open or close the cover.

The conventional rotatable connection apparatuses can be divided into two groups, one is realized by using a combination of a rotating shaft and a hole, or a combination of a groove and a pillar, another is realized by using multiple components (e.g., a gear set) to connect the cover to the main body of the product. Typically, the conventional approaches can only provide an ordinary function similar to a rotating shaft, i.e., to make the cover to be rotatable. In many applications, the user not only needs to rotate the cover but also wants to fix the cover in a certain position as his/her wish. That is, the cover has to immediately fix in the position where the user stops rotating the cover. However, the conventional approaches cannot achieve such a purpose.

Take a copy machine as an example. The user needs to open the cover of the copy machine and then puts the document to be copied on a copy platform when uses the copy machine. Afterward, the user needs to close the cover so as to execute the copy function. When opening the cover, if the user moves his/her hand from the cover to do another movement or just carelessly loosens his/her hand from the cover, the gravity may cause the cover to rapidly close, especially in the case where the included angle between the cover and the copy platform is not large enough. The impact of the cover against the main body of the copy machine easily causes damage to the copy machine and may harm the user's fingers. To avoid above situation, the user needs to pay attention to the cover when rotates the cover. Obviously, this is very inconvenient for the user.

### SUMMARY OF THE INVENTION

It is therefore an objective of the present invention to provide a rotatable connection apparatus that is capable of fixing an object to be rotated in a certain position by adjusting a friction to solve the above-mentioned problems.

An exemplary embodiment of a rotatable connection apparatus is disclosed comprising: a roller coupled to an object to be rotated, wherein the roller rotates with the rotation of the object; a frictional component for contacting a surface of the roller to provide a friction for fixing the object in a first position when the object is rotated to the first position; and an elastic component having a terminal coupled to the frictional component and another terminal coupled to an fixed position, wherein the elastic component is deformed to adjust the friction between the roller and the frictional component when the object is rotated to the first position.

The rotatable connection apparatus of the present invention utilizes the elastic component to adjust the friction between the roller and the frictional component so that the object to be rotated (e.g., the cover of a copy machine, scanner, or a multi-function product) can be fixed in a predetermined position. Accordingly, the cover will not rapidly close after the user loosens his/her hand from the cover due to the moment caused by the gravity is balanced by the friction. As a result, the inconvenience of the conventional rotatable connection apparatus can be significantly improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a rotatable connection apparatus according to an exemplary embodiment of the present invention.

FIG. 2 is a schematic diagram illustrating an example where a protrudent part of a cover of the rotatable connection apparatus of FIG. 1 touches a sliding component.

FIG. 3 is a schematic diagram illustrating that the cover of FIG. 2 is rotated to a position where the distance between the sliding component and a roller reaches a maximum value.

FIG. 4 is a schematic diagram illustrating an example where the protrudent part of the cover of FIG. 3 is about to leave the sliding component.

### DETAILED DESCRIPTION

The rotatable connection apparatus of the present invention comprises a roller, a frictional component, an elastic component, a groove, and a sliding component. For the purpose of explanatory convenience in the following description, it is herein assumed that the rotatable connection apparatus of the present invention is employed as the cover hinge of a copy machine to connect the cover and the main body of the copy machine. In such an application, the cover can be fixed in a position where the user loosens his/her hand from the cover when opening or closing the cover.

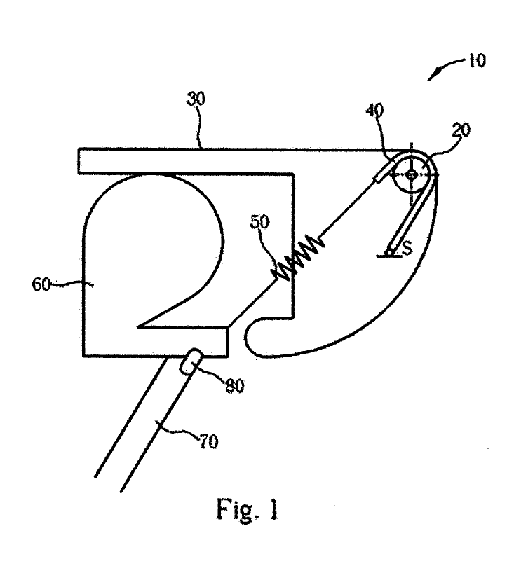

Please refer to FIG. 1, which shows a schematic diagram illustrating a rotatable connection apparatus 10 according to an exemplary embodiment of the present invention. The rotatable connection apparatus 10 comprises a roller 20, a cover 30, a flexible belt 40, a spring 50, a sliding component 60, and a groove 70. The bottom of the sliding component 60 is provided with a tenon 80 lodged in the groove 70 so that the sliding component 60 is able to freely slide along the groove 70. In this embodiment, the cover 30 is the object to be rotated, the flexible belt 40 is employed as a frictional component, and the spring 50 is employed as an elastic component. In addition, the roller 20 is arranged on the cover 30 and can rotate with the rotation of the cover 30. Please note that the cover 30 is in a close state in FIG. 1, i.e., the included angle between the cover 30 and the platform of the copy machine (not shown) is zero degree. At that moment, a protrudent part of the cover 30 does not contact to the sliding component 60. Accordingly, the sliding component 60 is at an initial position. On the other hand, the flexible belt 40 surrounds the surface of the roller 20 as illustrated in FIG. 1. One terminal of the flexible belt 40 is fixed in a fixed point S whose position is not changed when the cover 30 rotates. Another terminal of the flexible belt 40 is connected to the sliding component 60 via the spring 50. When the sliding component 60 is at the initial position, the spring 50 has a natural length, i.e., the spring 50 is not stretched.

When the user wants to open the cover 30, the user needs to apply a force to the cover 30 so as to drive the cover 30 to rotate. As can be derived from the foregoing descriptions, there is a contact surface between the flexible belt 40 and the roller 20. According to the friction law, when the roller 20 rotates with the rotation of the cover 30, a friction is generated between the flexible belt 40 and the roller 20, and the active direction of the friction is opposite to the rotation direction of the roller 20. In this embodiment, the materials of the roller 20 and the flexible belt 40 are selected and related mechanism is properly designed to avoid the rotation of the cover 30 from being influenced by the friction on the roller 20 before the protrudent part of the cover 30 touches the sliding component 60.

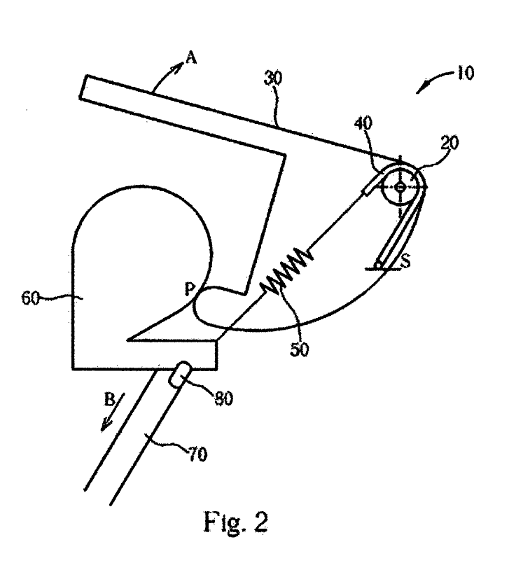

Please refer to FIG. 2, which shows a schematic diagram illustrating an example where the protrudent part of the cover 30 touches the sliding component 60. In contrast to the FIG. 1, the cover 30 in FIG. 2 is opened to a certain position, and the protrudent part of the cover 30 touches the sliding component 60 at a point P. Since the sliding component 60 is still at the initial position, the spatial relationship between the sliding component 60 and the roller 20 is not changed. Accordingly, the spring 50 still has a natural length, and the friction between the flexible belt 40 and the roller 20 is the same as that illustrated in FIG. 2. However, if the cover 30 continues to rotate toward a direction A, the protrudent part of the cover 30 pushes the sliding component 60 to move toward a direction B along the groove 70. Since the moving direction B of the sliding component 60 is a direction away from the roller 20, the sliding component 60 stretches the spring 50. Therefore, the spring 50 deforms and generates an elastic force. The elastic force stretches the flexible belt 40 so that the flexible belt 40 surrounds the roller 20 tighter than the case shown in FIG. 1. Accordingly, the friction between the flexible belt 40 and the roller 20 is greater than that before the protrudent part of the cover 30 pushing the sliding component 60 to move along the groove 70. By proper design, a moment on the roller 20 caused by the weight of the cover 30 can be balanced off by an opposite moment on the roller 20 caused by the friction at the time the cover 30 rotates to a first position. In other words, if the cover 30 stops rotating at the first position, the cover 30 will fix on the first position and does not close by the gravity.

It can be derived from the physical property of the spring 50 that the deformation of the spring 50 and the pulling force applied on the flexible belt 40 both increase as the distance between the sliding component 60 and the roller 20 increases. As described previously, the flexible belt 40 is flexible due to it is made by flexible materials. Accordingly, when the pulling force applied on the flexible belt 40 increases, the flexible belt 40 surrounds the roller 20 tighter and results in greater friction. Similarly, the moment on the roller 20 caused by the friction also increases correspondingly. If the friction is too large, the rotation smoothness of the cover 30 may be affected. In such a situation, the user needs to use more strength to open the cover 30. To avoid this, a proper mechanism design is employed in the present invention so that the moment caused by the gravity can be balanced off by the moment caused by the friction when the distance between the sliding component 60 and the roller 20 reaches a maximum value while maintaining the rotation smoothness of the cover 30.

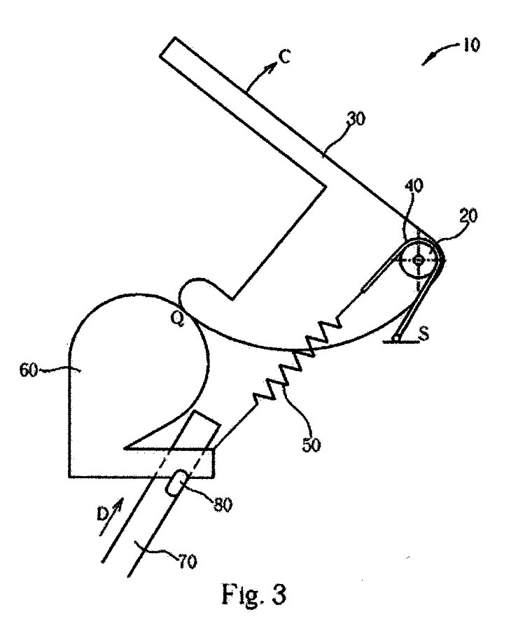

Please refer to FIG. 3, which shows that the cover 30 of FIG. 2 is rotated to a position where the distance between the sliding component 60 and the roller 20 reaches a maximum value. When the cover 30 rotates to a second position as illustrated in FIG. 3, the distance between the sliding component 60 and the roller 20 reaches a maximum value, and the protrudent part of the cover 30 touches the sliding component 60 at a point Q. At that time, the deformation of the spring 50 and the pulling force applied on the flexible belt 40 both reach a maximum level. Additionally, the friction between the flexible belt 40 and the roller 20 also reaches a maximum value when the cover 30 rotates to the second position. If the cover 30 continues to rotate toward a direction C, the protrudent part of the cover 30 does not push the sliding component 60 to move away from the roller 20 any more. Instead, the sliding component 60 moves toward a direction D along the groove 70 by the pulling force of the spring 50. The pulling force applied on the flexible belt 40 then decreases as the deformation of the spring 50 decreases. Accordingly, the friction between the flexible belt 40 and the roller 20 also decreases correspondingly. At that moment, since there is a considerable included angle between the cover 30 and the horizontal plane, the moment on the roller 20 caused by the weight of the cover 30 is not as large as that in the previous cases. Thus, although the friction between the flexible belt 40 and the roller 20 is smaller than that in the previous cases, the moment on the roller 20 caused by the gravity can still be balanced off by the moment on the roller 20 caused by the friction. This also renders that the user can easily rotate the cover 30.

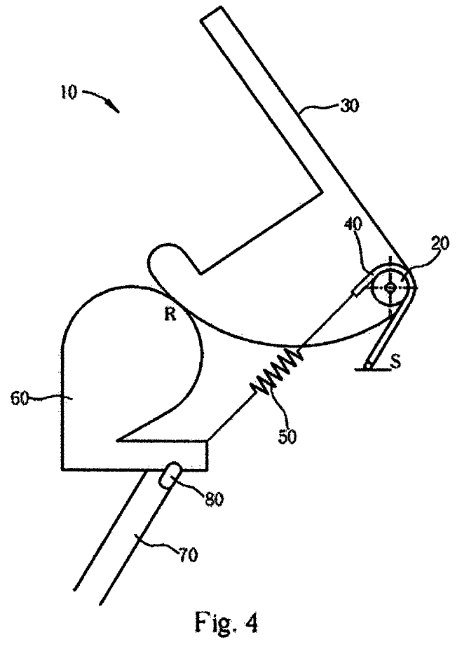

Please refer to FIG. 4, which shows a schematic diagram illustrating an example where the protrudent part of the cover 30 is about to leave the sliding component 60. As illustrated in FIG. 3, if the cover 30 of the rotatable connection apparatus 10 continues to rotate toward the direction C, the deformation of the spring 50 gradually decreases until the spring 50 returns to the natural length, i.e., the sliding component 60 returns to the initial position. At that time, the cover 30 touches the sliding component 60 at a point R. If the user continues to rotate the cover 30, the cover 30 will leave the sliding component 60. As in the foregoing descriptions, the materials of the roller 20 and the flexible belt 40 are selected and related mechanism is properly designed to avoid the rotation of the cover 30 from being influenced by the friction on the roller 20 after the protrudent part of the cover 30 leaves the sliding component 60. As the included angle between the cover 30 and the horizontal plane increases, the moment on the roller 20 caused by the gravity decreases. As a result, the user can open the cover 30 easier after the cover 30 leaves the sliding component 60. In one aspect, the rotatable connection apparatus 10 of the present invention can speed up the rotation speed of the object to be rotated after the rotation angle exceeds a predetermined value. The cover 30 is typically regarded as full open when the included angle between the cover 30 and the copy platform of the copy machine (not shown) reaches 90 degrees. Generally, the copy machine is provided with a limiter to restrict the rotatable range of the cover 30 so that the included angle between the cover 30 and the copy platform of the copy machine cannot exceed 90 degrees.

As in the foregoing embodiment, the entire operations of opening the cover 30 from it is completely closed to completely opened are described. The same principle can also be applied on the operations of closing the cover 30 from it is completely opened to completely closed. Additionally, the copy machine is merely an example of application rather than a restriction of the practical applications of the present invention. In practice, the disclosed rotatable connection apparatus 10 can be applied in various devices, such as scanners and multi-function products. Since the rotatable connection apparatus 10 is able to fix the cover 30 in any position where the user leaves his/her hand, the safety and convenience of using these devices can be significantly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A rotatable connection apparatus comprising:
a roller coupled to an object to be rotated, wherein the roller rotates with the rotation of the object;
a frictional component for contacting a surface of the roller to provide a friction for fixing the object in a first position when the object is rotated to the first position; and
an elastic component having a terminal coupled to the frictional component and another terminal coupled to an fixed position,
wherein the elastic component is deformed to adjust the friction between the roller and the frictional component when the object is rotated to the first position.

2. The rotatable connection apparatus of claim 1, wherein the object to be rotated comprises a protrudent part, and the rotatable connection apparatus further comprises:
a groove; and
a sliding component positioned on the groove, when the object to be rotated is rotated to the first position, the protrudent part drives the sliding component to move away from the roller along the groove so that the elastic component deforms;
wherein the elastic component having a terminal coupled to the elastic component and another terminal coupled to the sliding component.

3. The rotatable connection apparatus of claim 2, wherein the protrudent part stops driving the sliding component when the object is rotated to a second position.

4. The rotatable connection apparatus of claim 1, wherein the frictional component is made by flexible materials.

5. The rotatable connection apparatus of claim 1, wherein the elastic component is a spring.

6. The rotatable connection apparatus of claim 1, wherein the object to be rotated is a cover.

7. The rotatable connection apparatus of claim 6, wherein the cover is arranged on a copy machine, a scanner, or a multi-function product.
